(19) United States
(12) Patent Application Publication
(10) Pub. No.: US 2014/0170014 A1
(43) Pub. Date: Jun. 19, 2014

(54) METHOD FOR PRODUCING MAGNETIC POWDER AND MAGNET

(71) Applicants: KOREA INSTITUTE OF MACHINERY & MATERIALS, Daejeon (KR); HYUNDAI MOTOR COMPANY, Seoul (KR)

(72) Inventors: Jae Ryung Lee, Hwaseong (KR); Ji Hun Yu, Busan (KR); Jung Goo Lee, Jinhae (KR)

(73) Assignees: KOREA INSTITUTE OF MACHINERY & MATERIALS, Daejeon (KR); HYUNDAI MOTOR COMPANY, Seoul (KR)

(21) Appl. No.: 13/874,735

(22) Filed: May 1, 2013

(30) Foreign Application Priority Data
Dec. 13, 2012 (KR) 10-2012-0145818

(51) Int. Cl. H01F 41/02

(52) U.S. Cl. CPC H01F 41/0246
USPC 419/65; 75/348

(57) ABSTRACT

Disclosed is a method for producing a magnetic powder comprising: a first step of producing a R—Fe—B-based rare earth isotropic magnetic powder using a scrap rare earth magnet through a HDDR process; and a second step of mixing the R—Fe—B-based rare earth isotropic magnetic powder with an anisotropic magnetic powder, and a method for producing a magnet using the magnetic powder.

### CROSS-REFERENCE TO RELATED APPLICATION

This application claims under 35 U.S.C. §119(a) the benefit of Korean Patent Application No. 10-2012-0145818 filed Dec. 13, 2012 the entire contents of which are incorporated herein by reference.

### BACKGROUND

(a) Technical Field

The present invention relates to a method for producing magnetic powder and a method for producing a magnet, particularly a method for producing a bonded magnet by the addition of anisotropic rare earth magnet powder in a certain amount. More particularly, the present invention provides a bonded magnet in which an anisotropic rare earth magnet powder is added, thereby improving magnetic characteristic of an isotropic bonded magnet produced from a scrap of a rare earth permanent magnet by hydrogenation.

(b) Background Art

An Nd-based rare earth magnet having high magnetic anisotropic constant and coercivity is used as a major material of motors for vehicles and industrial applications. Particularly, in a hybrid vehicle industry and wind power generation industry, demands for motors having excellent efficiency are gradually increasing. Accordingly, the demand for Nd-based rare earth magnets is on the rise.

Nd-based rare earth magnets include sintered magnet types, which are produced by molding and sintering the Nd-based rare earth magnet powder, and bonded magnet types, which are produced by mixing magnet powder with epoxy followed by molding into a magnet having the desired complicated shape. Sintered magnets, which produce a large amount of energy (BH(max)), are mainly used in large motors such as driving motors. Bonded magnets, which produce energy in a smaller amount of 30˜60% as compared to the sintered magnet, are mainly used in an electric motor, such as a fan motor and a seat motor.

An Nd—Fe—B magnetic powder material, which has been used to form bonded magnets, is weak in oxidation because the powder surface formed thereby is exposed to the air, and it has lower squareness than the sintered magnet due to various defects on the powder surface. In order to overcome these shortcomings, the defects on the powder surface are removed so as to improve the magnetic characteristic.

Squareness is one of the indicators showing the magnetic characteristics of permanent magnets.

The squareness is a term describing the curve shape in the second quadrant of the hysteresis loops of permanent magnets wherein the magnetization value little decreases but rapidly decreases around coercivity in magnets with a strong magnetic characteristics such as a sintered magnet, even though the magnitude of a diamagnetic field increases, and in this case it is said that the squareness is excellent.

In contrast, as for bonded magnets, it is said that the squareness is low, when the magnetization value keeps decreasing in accordance with the magnitude of a diamagnetic field.

The bonded magnets shows lower squareness than sintered magnets, because the defect on the powder surface acts as a site of a reverse magnetic domain due to exposure of the surface of the magnetic powder.

(NOTE: Squareness is given by the ratio Hk/HcJ, Hk being the reverse field giving an induction of 0.90.Br and HcJ being the coercive field (kA/m). Hk in fact corresponds to the field from which magnetic losses are considered to be irreversible. Ideal squareness ratio is 1.)

On the other hand, the Nd—Fe—B sintered magnet uses expensive rare earth elements as a major raw material. Accordingly, in comparison with a ferrite magnet, the price of a motor produced using the rare earth magnet is increased due to its higher production cost. Further, deposits of the rare earth element are limited compared with other metals. Therefore, in order to expand fields for applying the rare earth magnet and provide adequate supply based on the demand, methods for producing cheaper magnets are needed, for example, a method which recycles discarded rare earth magnets.

Further, rare earth sintered magnets are produced by a general powder metallurgy process and processing. During production, scraps are generated at a ratio of 30˜40% (i.e. 30˜40% scraps, 70˜60% produced magnets). These expensive rare earth magnet scraps are not reused directly. Instead, they are passed through a process in which the rare earth metals are extracted by refining. Accordingly, additional processing cost for recycling are expended.

Therefore, a demand exists for a method of recycling cheap starting materials, such as rare earth sintered magnet goods which are recovered from scraps produced from a process for producing a rare earth sintered magnet, defective goods, and discarded goods, to obtain cheaper powders for use in producing a rare earth bonded magnet.

KR10-2002-0087827 A describes a conventional “Isotropic powdery magnet material, process for preparing and resin-bonded magnet” and suggests that “a flake-like isotropic SmFeN powdery magnetic material prepared by rapid cooling alloy casting using a cooling roll followed by nitrating the alloy power thus obtained to obtain as a magnet alloy, wherein the magnet alloy has the following alloy composition by at %, SmxFe100-x-vNv (wherein, each at % range is 7≦x≦12, 0.5≦v≦20, and its crystal structure is TbCu7 type and thickness of flake is 10˜40 μm).”

However, according to the described method, there is a limit to the ability of producing magnetic powder and a magnet which are sufficiently inexpensive and which demonstrate good magnetic characteristics.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above-described problems associated with prior art. The present invention provides a method for producing magnetic powder and a method for producing a magnet. In particular, the present invention provides a method for producing a bonded magnet by adding anisotropic rare earth magnet powder in a certain amount. According to the present, magnetic characteristics of an isotropic bonded magnet produced from a scrap of a rare earth permanent magnet by hydrogenation can be improved by the addition of an anisotropic rare earth magnet powder in a certain amount.

According to one aspect, the present invention provides a method for producing magnetic powder comprising: a first step of producing R—Fe—B-based rare earth isotropic magnetic powder using a scrap rare earth magnet through a HDDR (Hydrogenation-Disproportionation-Hydrogen Desorption-Recombination) process; and a second step of adding and mixing an anisotropic magnetic powder to the R—Fe—B-based rare earth isotropic magnetic powder.

According to various embodiments, the scrap rare earth magnet is recovered from process scraps produced from a process for producing a rare earth sintered magnet, defective goods and/or discarded goods.

According to various embodiments, in the first step, the HDDR process is conducted by using the rare earth scrap magnet ground to an average particle size of about 0.1˜1000 μm.

According to various embodiments, in the hydrogenation process of the HDDR process, the rare earth scrap magnet is charged and vacuumed to about 2*10-2 torr or less, and hydrogen is filled up to about 0.3˜1.0 atm.

According to various embodiments, in the disproportionation process of the HDDR process, the temperature is maintained at about 780˜830° C. for about 10 min˜1 hour.

According to various embodiments, in the desorption process in the HDDR process, the hydrogen is released up to a pressure of about 200 torr, and the pressure is maintained for about 5˜20 min.

According to various embodiments, in the first step, the produced isotropic magnetic powder is coated with an amide-based lubricant.

According to various embodiments, in the second step, common anisotropic SmFeN powder and/or common anisotropic NdFeB powder is mixed with the isotropic magnetic powder produced in the first step at a ratio of about 5˜95 wt %, wherein the wt % is the weight of the common anisotropic powder based on the total weight of the common anisotropic powder and the isotropic magnetic powder produced in the first step.

According to various embodiments, in the second step, common anisotropic SmFeN powder and common anisotropic NdFeB powder are together mixed with the isotropic magnetic powder produced in the first step, wherein the common anisotropic SmFeN powder is mixed at a ratio of about 15˜25 wt %, wherein the wt % is the weight of the common anisotropic powder based on the total weight of the common anisotropic powder and the isotropic magnetic powder produced in the first step.

According to various embodiments, the isotropic magnetic powder produced in the first step is ground to an average particle size of about 100˜225 μm, the common anisotropic SmFeN powder is ground to an average particle size of about 3˜5 μm, and the common anisotropic NdFeB powder is ground to an average particle size of about 130˜170 μm before mixing of these components together.

According to another aspect, a method for producing a magnet comprises: a first step of producing R—Fe—B-based rare earth isotropic magnetic powder using a scrap rare earth magnet through a HDDR process; a second step of mixing an anisotropic magnetic powder with the rare earth isotropic magnetic powder from the first step; a third step of kneading, into the mixture of the second step, a thermosetting or thermoplastic synthetic resin; and a fourth step of forming a magnetic field using a magnetic field forming machine.

According to various embodiments, in the third step, the synthetic resin (thermosetting or thermoplastic synthetic resin) is kneaded at a ratio of about 1˜10 wt %, wherein the wt % is the weight of the synthetic resin based on the total weight of the isotropic magnetic powder, anisotropic magnetic powder and synthetic resin.

According to various embodiments, in the third step, the synthetic resin is knead followed by drying at about 60° C. or less under a vacuum condition for about 30 min˜2 hours.

According to various embodiments, in the fourth step, a magnetic field compression-molded body having the density of about 5.5 g/cc or more at a pressure of about 6˜14 ton/cm² or less is molded.

According to various embodiments, in the fourth step, the magnetic field compression-molded body is heat-treated at about 130˜170° C. for about 30 min˜2 hours after molding.

According to various embodiments, the method further comprises a fifth step of heating at about 80˜120° C. for about 20˜40 min.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a drawing showing a crack inside the magnetic body by application of excessive pressure;

FIGS. 2 to 4 are graphs showing the effect of the method for producing magnetic powder according to one embodiment of the present invention; and

FIG. 5 is a table showing the effect of the method for producing magnet according to one embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the method for producing magnetic powder and the method for producing a magnet according to preferable embodiments of the present invention now will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The method for producing magnetic powder of the present invention comprises: a first step of producing R—Fe—B-based rare earth isotropic magnetic powder using a scrap rare earth magnet through a HDDR (Hydrogenation-Disproportionation-Hydrogen Desorption-Recombination) process; and a second step of mixing the anisotropic magnetic powder.

As such, according to the present invention, in producing a R—Fe—B-based powder for a bonded magnet, a rare earth sintered magnet scrap is used as a starting material so as to dramatically reduce production costs. The scrap may be scraps from rare earth sintered magnet goods, which are recovered from a process for producing a rare earth sintered magnet, defective goods, and/or discarded goods (i.e., hydrogenation, disproportionation and desorption processes). Further, a HDDR process is used so as to improve coercivity and thermal stability of the powder.

However, it was found that when the rare earth powder and the bonded magnet are produced by the above process, magnetic defects such as oxidation or mechanical residual stress may be generated, and consequently, the coercivity may be reduced in reverse proportion to the powder particle size. Particularly, when going through a curing process in a temperature range of about 100˜150° C., the magnetic characteristics may become instable as the magnetic defect effect on the surface increases.

In order to solve these problems, the smoothness and thermal stability were improved by removing the defects through a coating process. In particular, the rare earth magnetic powder surface was coated with a second phase. It was found that while a material such as Dy can be used as a second phase, Dy is a very expensive heavy rare earth element. Further, when Dy is added, overall energy may be reduced due to reduction of magnetization of the rare earth magnet. Further, when coating the inexpensive rare earth powder with the expensive Dy, it may become difficult to secure sufficiently low production costs.

Thus, the present invention provides a method for removing defects on the surface of the powder using a material cheaper than Dy. In particular, according to preferred embodiments, the present invention provides a method wherein Nd, which is a basic material of a rare earth permanent magnet and is cheaper than the Dy, is used to coat the rare earth magnetic powder surface.

Generally, for the production of a rare earth sintered magnet, a method is carried out for improving magnetic characteristics by a de-coupling effect, which is generated by adding a somewhat larger amount of Nd than the stoichiometric amount of the Nd—Fe—B composition, thereby widely distributing Nd-rich phases as a non-magnetic body on the interface of a particle. However, a rare earth magnetic powder produced by an HDDR process is characterized in that there is no Nd-rich phase on the internal interface of the powder. The absence of such an Nd-rich phase is due to the addition of an exact or near exact stoichiometric amount.

The thus formed the isotropic powder produced by the HDDR process has excellent coercivity, but has low residual magnetization (7.5 kG). Accordingly, there may be a limit to application of the powder to a motor that requires high magnetization characteristics. Therefore, the present invention provides a method wherein the R—Fe—B anisotropic powder or the SmFeN anisotropic powder, which both have high residual magnetization, are added to the isotropic powder produced by the HDDR process. By this addition, the residual magnetization value can be largely increased, and through this, the powder can be suitably applied to a motor, the requires high magnetization characteristics.

Generally, the Nd—Fe—B anisotropic powder having excellent residual magnetization has high residual magnetization of about 13 kG and high coercivity of about 14.5 kOe. Further, it is known that the SmFeN anisotropic powder has excellent residual magnetization of about 13.8 kG, but its coercivity value is 9.8 kOe, which is somewhat lower than that of the anisotropic R—Fe—B powder.

Accordingly, in the present invention, a bonded magnet, which is prepared by partially mixing the anisotropic R—Fe—B powder and the SmFeN anisotropic powder to the R—Fe—N isotropic powder produced from the scrap powder, improves the magnetic characteristic more than the bonded magnet using only the scrap powder.

Specifically, according to embodiments of the present invention, the method for producing magnetic powder comprises: a first step of producing R—Fe—B-based rare earth isotropic magnetic powder using scrap rare earth magnet materials through an HDDR process; and a second step of mixing the anisotropic magnetic powder with the R—Fe—B-based rare earth isotropic magnetic powder from the first step.

In particular, the first step comprises grinding the scrap rare earth magnet with a grinder and then producing the R—Fe—B-based rare earth magnetic powder using the HDDR process.

According to various embodiments, the scrap or waste magnet comprises those which include rare earth elements (e.g. Nd, Pr, Dy, Tb, Sm, Y and the like) at about 20˜35 wt %, transition metals (e.g., Co, Al, Cu) at about 1˜3 wt %, about 0.5˜1.5 wt % B, and a balance of Fe, wherein wt % are based on the total weight of the waste magnet composition.

According to various embodiments, as a starting material one or more of the following can be used: rare earth sintered magnet goods, which are recovered from process scraps produced from a process for producing a rare earth sintered magnet, defective goods, and discarded goods. These are coarsely ground to the desired size, which is preferably an average particle size of about 0.1˜1000 μm. Preferably, the starting material is a R—Fe—B-based rare earth sintered magnet scrap that is coarsely ground to an average size of about 0.1˜1000 μm.

If the sintered magnet scrap is finely ground to a size of less than about 0.1 μm, there is a problem in that the surface area of the powder is increased, and as a result, it is excessively exposed to oxygen during the HDDR process. On the other hand, and if the size is greater than about 1000 μm, there is a problem in that its volume is increased and decreased by phase change during the HDDR process, thereby resulting in cracks inside of the powder.

In the case of the hydrogenation process of the HDDR process, when the scrap used as a starting material was composed of a R2Fe14B+R-rich type compound phase, it was found that if 6 g of the ground powder was charged to a tube furnace, initial vacuum was maintained at 2*10-5 torr or less, hydrogen gas was filled up to 1.0 atm and then temperature was increased from room temperature to 200° C. so as to complete the hydrogenation process, then the powder was combined with the hydrogen, thereby forming a hydrogen compound of R2Fe14BHX+RHX.

It was thus determined that it is preferred to maintain the vacuum at about 2*10-2 torr or less and then fill up the hydrogen to about 0.3˜1.0 atm. If the hydrogen pressure is less than 0.3 atm, there is a problem in that the HDDR process is not fully reacted. On the other hand, if the pressure is over about 1.0 atm, there is a problem in that the process costs increase due to the requirement for extra equipment to handle high pressure hydrogen gas.

In particularly, isotropic powder, which may have high coercivity at 1 atm, can be produced, and anisotropic powder, which may have high residual magnetic flux density at 0.3 atm, can be produced.

Thereafter, in the disproportionation process, the temperature of the tube furnace of hydrogen atmosphere was increased up to 810° C. and maintained for 10 min˜1 hour so as to complete the disproportionation process into α-Fe+Fe2B+NdHX. Because the disproportionation can be completed before 1 hour, the cost is increased when the process time is over 1 hour and, thus, it is preferred to limit the time to no greater than about 1 hour. On the other hand, when the time is less than about 10 min, the disproportionation process is incompletely finished, and thereby the magnetic characteristics are reduced.

Next, in the desorption process is carried out. In particular, hydrogen in the tube furnace was released up to a hydrogen pressure of about 200 torr, and the pressure was maintained for about 5˜20 min.

Subsequently, the recombination process was conducted while vacuum exhausting the hydrogen in the tube furnace to produce the R—Fe—B-based rare earth magnetic powder.

In order to enhance corrosion resistance of the powder, an amide-based lubricant solution was mixed thereto, the solvent in the solution was removed, and then the resulting mixture was mixed in a mixing blender for about 30 min˜2 hours so as to produce the powder whose surface was coated with the amide-based lubricant.

In the second step of mixing the anisotropic magnetic powder, common anisotropic SmFeN powder or common anisotropic NdFeB powder can be mixed with the isotropic magnetic powder produced in the first step at a ratio of about 5˜95 wt %, wherein the wt % is the weight of the SmFeN powder or NdFeB powder relative to the total weight of the R—Fe—B-based rare earth magnetic powder plus the SmFeN powder or NdFeB powder. Alternatively, in the second step, the common anisotropic SmFeN powder can be mixed with the isotropic magnetic powder produced in the first step together with the common anisotropic NdFeB powder. In this case, the common anisotropic SmFeN powder is preferably mixed thereto at a ratio of about 15˜25 wt %, wherein the wt % is the weight of the SmFeN powder relative to the total weight of the R—Fe—B-based rare earth magnetic powder plus the SmFeN powder or NdFeB powder.

According to various embodiments, the isotropic magnetic powder produced in the first step can be ground to an average particle size of about 100˜225 μm, the common anisotropic SmFeN powder can be ground to an average particle size of about 3˜5 μm, and the common anisotropic NdFeB powder can be ground to an average particle size of about 130˜170 μm before mixing.

According to various embodiments, the second step includes mixing the powder at a certain ratio. In particular, the HDDR isotropic coarse powder (100˜225 μm) formed using scrap and the common SmFeN powder (3˜5 μm), which comprises a binder (epoxy) and a lubricant, are mixed at the ratio of HDDR isotropic powder(100-X)SmFeN(X), wherein X=5˜95 wt % using a mixing blender or the like for about 30 min˜2 hours.

In another embodiment, the HDDR isotropic coarse powder (100˜225 μm) formed using scrap and the common anisotropic NdFeB powder (150 μm), which comprises a binder (epoxy) and a lubricant, are mixed at the ratio of HDDR isotropic powder(100-X)SmFeN(X), wherein X=5˜95 wt % using a mixing blender or the like for about 30 min˜2 hours.

In another embodiment, the HDDR isotropic coarse powder (100˜225 μm) formed using scrap, and the common anisotropic NdFeB powder (150 μm) and the common SmFeN powder (3˜5 μm), which comprises a binder (epoxy) and a lubricant, are mixed at the fixed ratio of HDDR isotropic powder+common anisotropic NdFeB powder=80 wt %, common SmFeN=20 wt % using a mixing blender or the like for about 30 min˜2 hours.

According to various embodiments, the present invention provides a method for producing a magnet comprising: a first step of producing R—Fe—B-based rare earth isotropic magnetic powder using a scrap rare earth magnet through a HDDR process; a second step of adding and mixing an anisotropic magnetic powder with the R—Fe—B-based rare earth isotropic magnetic powder from the first step; a third step of kneading a thermosetting or thermoplastic synthetic resin into the powder formed in the second step; and a fourth step of forming a magnetic field using a magnetic field forming machine.

According to various embodiments, the first step and the second step are identical with the steps of forming the magnetic powder.

According to various embodiments, in the third step, thermosetting or thermoplastic synthetic resin can be kneaded at an amount of about 1˜10 wt %, based on the total weight of the thermosetting or thermoplastic synthetic resin plus the anisotropic magnetic powder and the R—Fe—B-based rare earth isotropic magnetic powder. The resulting material can then be dried in a vacuum at a temperature of about 60° C. or less for about 30 min˜2 hours after kneading the synthetic resin.

Namely, the third step is a step of kneading thermosetting or thermoplastic synthetic resin into the powder of the second step followed by forming and molding the mixture so as to form a compressed bonded magnet.

The synthetic resin can be selected from any such known resins according to the method for producing the bonded magnet, and in the case of the compressed bonded magnet, a thermosetting resin such as epoxy-based resin, phenol-based resin and urea-based resin are particularly suitable.

Generally, a compression type method is preferable to produce a magnet having high density, and preferably, when producing the compressed bonded magnet, the synthetic resin is preferably added in an amount of about 1˜10 wt % based on the total weight of the bonded magnet. The epoxy resin is preferably mixed in an amount of about 1˜10 wt %, and then a hardening agent (e.g. 6.6 g), a hardening accelerator (e.g. 1.7 g) and acetone (e.g. 100 ml) are mixed to prepare a binder. If the content of the synthetic resin and the epoxy resin is individually less than 1 wt %, there is a problem in that the resin generally will not completely coat the powder, thereby resulting in a lower bonding strength. On the other hand, if the content of the synthetic resin and the epoxy resin is individually over 10 wt %, there is a problem of lowering molding density of the magnet. After the components are added, the powder is put into a mixing blender or the like and mixed for about 30 min.

After mixing, the composition is dried in a vacuum oven at a temperature of about 60° C. or less for about 30 min˜2 hours. When the drying time is less than 30 min, the solvent generally will not be completely removed. On the other hand, if the time is over 2 hours, the magnetic characteristic is lowered due to oxidation on the powder surface. After deagglomeration, an internal lubricant is added in an amount of about 0.01˜0.2 wt %, relative to the total weight of the powder. If the amount is less than 0.01 wt %, fluidity of the powder is reduced and the powder is worn out when molding in a mold. After molding, the outside of the mold should be desulfurized. However, if the amount lubricant is greater than 0.2 wt %, the sulfur, which remains as it is around the powder, decreases molding density so as to reduce magnetic characteristics.

Then, the fourth step of forming a magnetic field using a magnetic field forming machine is conducted. In the fourth step, a magnetic field compression-molded body having density of about 5.5 g/cc can be molded at a pressure of about 6˜14 ton/cm². According to various embodiments, in the fourth step, the magnetic field compression-molded body can be heat-treated at about 130˜170° C. for about 30 min˜2 hours after molding.

Namely, the fourth step is a step of forming a magnetic field in the mixture formed by the third step using a magnetic field forming machine. The produced compound is molded into a magnetic field compression-molded body having a suitable density, for example a density of about 5.5 g/cc, and a desired dimension of diameter (mm)×height (mm) using a press at pressure of about 6˜14 ton/cm² or less. Thereafter, the body is heat-treated at about 150° C. for about 30 min˜2 hours. When the pressure is less than about 6 ton/cm², the molding density is lower than 5 g/cc, thereby providing reduced magnetic characteristics. On the other hand, when the pressure is over 14 ton/cm², there is a problem in that cracks occur inside the magnet body by such high molding pressures when molding.

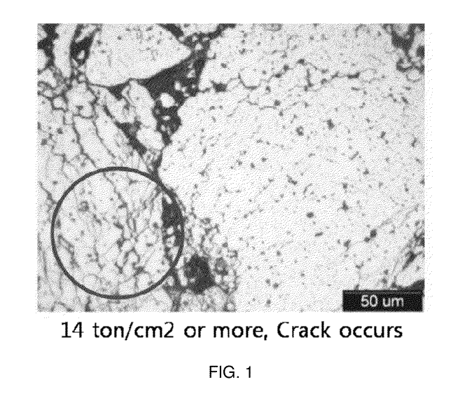

When the powder form is broken down to its structural phase, it is composed of a very sharp structure, in which coercivity and squareness is reduced by accelerating generation of diamagnetic field nucleation. For reference, as shown in FIG. 1, a grain boundary was observed inside the aggregate, which was estimated to be formed by miniaturization of the crystal by the HDDR process.

According to various embodiments, the present invention may further comprise a fifth step of heating at about 80˜120° C. for about 20˜40 min. The fifth step is a step of hardening the molded body from the fourth step by heating, for example, at about 100° C. for about 30 min. As a result, the powder is arranged in a fixed direction due to the anisotropic powder mixed therein, and it can demonstrate higher performance than the isotropic powder.

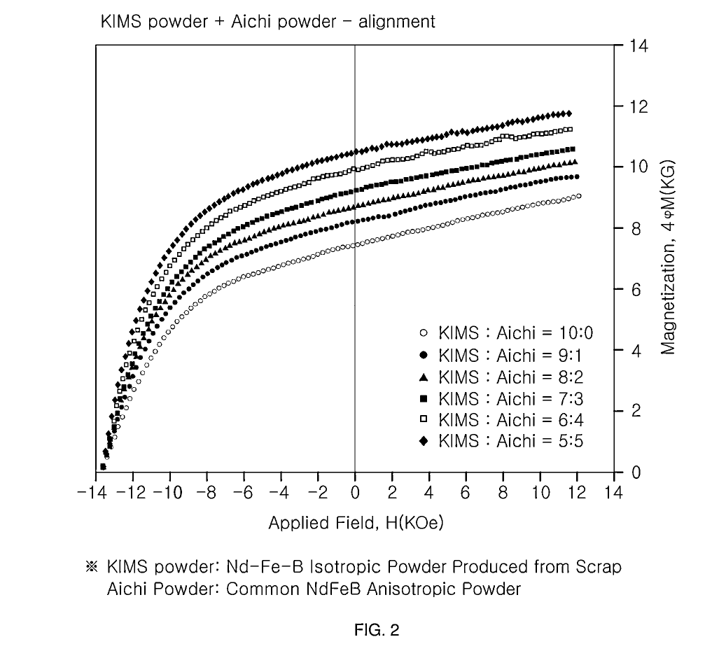

The following Table and FIG. 2 show the change of the magnetic characteristic based on the mixed amount when mixing the anisotropic Nd—Fe—B powder produced by the HDDR process with the Nd—Fe—B isotropic powder produced from the scrap.

TABLE 1

| Mixing Ratio | | |
|---|---|---|
| (Scrap NdFeB Isotropic | | |
| powder:Common Anisotropic Powder) | Br | iHc |
| 10:0 | 7.37 | 13.75 |
| 9:1 | 8.19 | 13.76 |
| 8:2 | 8.64 | 13.7 |
| 7:3 | 9.17 | 13.7 |
| 6:4 | 9.88 | 13.71 |
| 5:5 | 10.44 | 13.69 |

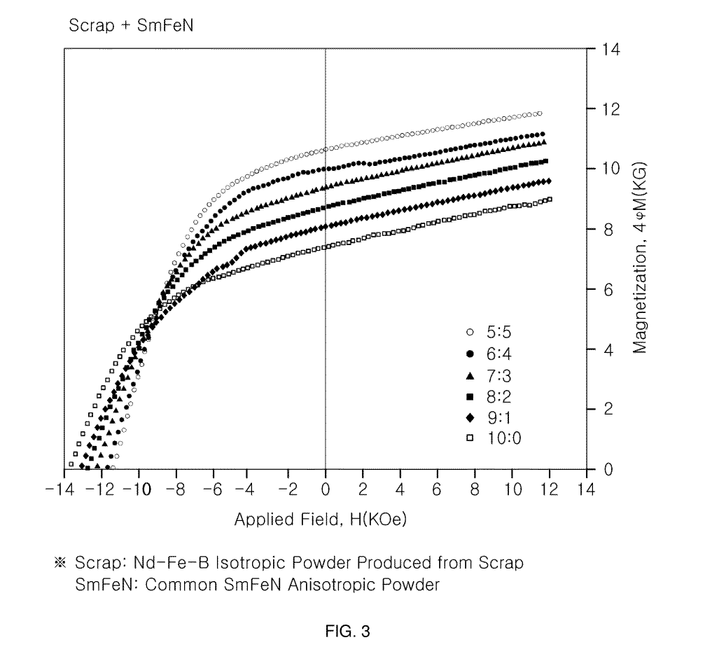

The following Table and FIG. 3 show the change of the magnetic characteristic based on the mixed amount when mixing the common Sm—Fe—B anisotropic powder with the Nd—Fe—B powder produced from the scrap.

TABLE 2

| Mixing Ratio | | |
|---|---|---|
| (Scrap:SmFeN)- | | |
| Arranged | Br | iHc |
| 10:0 | 7.37 | 13.7 |
| 9:1 | 8.07 | 13.1 |
| 8:2 | 8.73 | 12.6 |
| 7:3 | 9.37 | 12.2 |
| 6:4 | 10 | 11.5 |
| 5:5 | 10.64 | 11.2 |
| 0:10 | 13.8 | 9.8 |

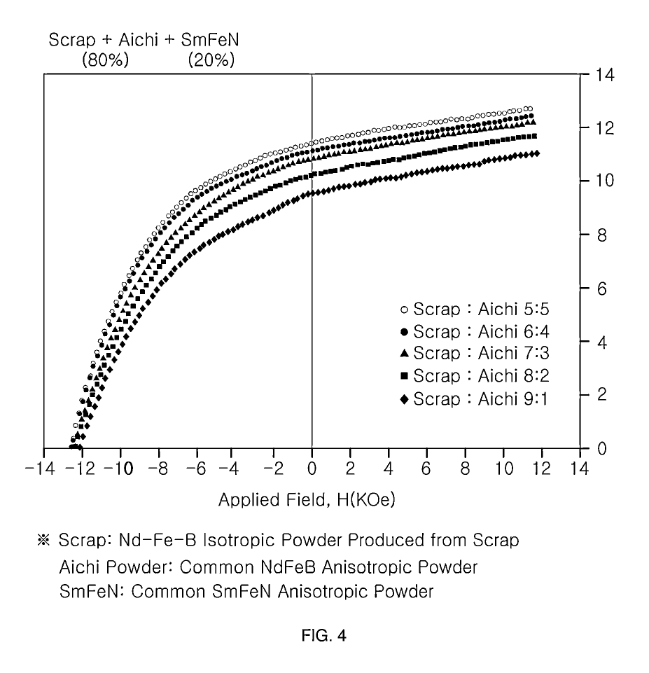

The following Table and FIG. 4 show the change of the magnetic characteristic based on the mixed amount when mixing the common Sm—Fe—B anisotropic powder and the common NdFeB powder with the Nd—Fe—B powder produced from the scrap.

TABLE 3

| Mixing Ratio | | |
|---|---|---|
| (Scrap + Aichi += 80% + | | |
| (SmFeN = (20%) <- 20% fixed)-Arranged | Br | iHc |
| Scrap:Aichi 5:5 | 11.4 | 12.6 |
| Scrap:Aichi 6:4 | 11.17 | 12.5 |
| Scrap:Aichi 7:3 | 10.82 | 12.5 |
| Scrap:Aichi 8:2 | 10.2 | 12.5 |
| Scrap:Aichi 9:1 | 9.5 | 12.2 |

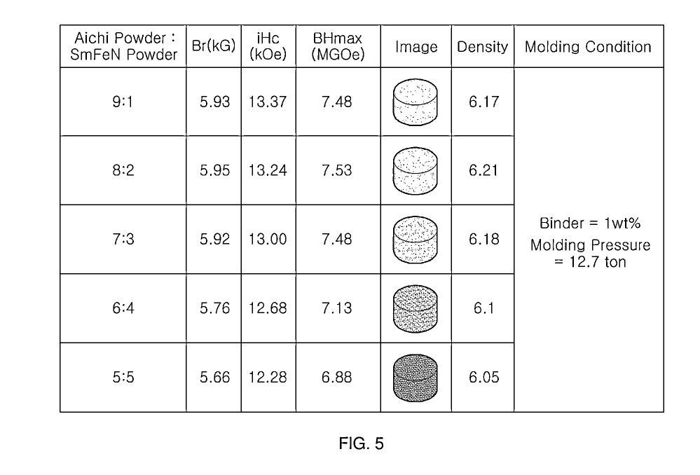

FIG. 5 shows the change of the magnetic characteristic of the magnet sample formed by mixing the common Sm—Fe—B anisotropic powder and the common NdFeB powder with the Nd—Fe—B powder produced from the scrap, followed by forming a magnetic field.

According to the method for producing magnetic powder and the method for producing a magnet having the constitution described above, the powder and the magnet can be produced at low cost by using the waste magnet and Nd, and low moldability and magnetic characteristic of the scrap powder can be improved by adding the R—Fe—B anisotropic powder or the SmFeN anisotropic powder. Accordingly, it can be suitably used in materials for high performance bonding.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A method for producing a magnetic powder comprising:
a first step of producing a R—Fe—B-based rare earth isotropic magnetic powder using a scrap rare earth magnet through a hydrogenation, disproportionation, hydrogen desorption, recombination (HDDR) process; and
a second step of mixing the R—Fe—B-based rare earth isotropic magnetic powder with an anisotropic magnetic powder.

2. The method for producing magnetic powder according to claim 1, wherein the scrap rare earth magnet is recovered from process scraps produced from a process for producing a rare earth sintered magnet, defective goods, discarded goods and combinations thereof.

3. The method for producing magnetic powder according to claim 1, wherein in the first step, the HDDR process is conducted using the rare earth scrap magnet ground to an average particle size of about 0.1˜1000 μm.

4. The method for producing magnetic powder according to claim 1, wherein a hydrogenation process in the HDDR process comprises charging the scrap rare earth magnet, applying vacuum to about 2*10-2 torr or less and then supplying hydrogen to provide a pressure of about 0.3˜1.0 atm.

5. The method for producing magnetic powder according to claim 1, wherein a disproportionation process in the HDDR process comprises maintaining a temperature at about 780˜830° C. for about 10 min to about 1 hour.

6. The method for producing magnetic powder according to claim 1, wherein a desorption process in the HDDR process comprises releasing hydrogen to provide a pressure of about 200 torr and maintaining the pressure for about 5˜20 min.

7. The method for producing magnetic powder according to claim 1, wherein the first step further comprises coating the produced isotropic magnetic powder with an amide-based lubricant.

8. The method for producing magnetic powder according to claim 1, wherein the anisotropic magnetic powder is selected from common anisotropic SmFeN powder and common anisotropic NdFeB powder, and wherein the anisotropic magnetic powder is mixed with the isotropic magnetic powder produced in the first step at a ratio of about 5˜95 wt % based on the total weight of the isotropic magnetic powder plus the anisotropic magnetic powder.

9. The method for producing magnetic powder according to claim 1, wherein the anisotropic magnetic powder is a combination of common anisotropic SmFeN powder and common anisotropic NdFeB powder, wherein the common anisotropic SmFeN powder is mixed at the ratio of about 15˜25 wt % based on the total weight of the isotropic magnetic powder plus the anisotropic magnetic powder.

10. The method for producing magnetic powder according to claim 8, wherein the isotropic magnetic powder produced in the first step is ground to an average particle size of about 100˜225 μm, the common anisotropic SmFeN powder is ground to an average particle size of about 3˜5 μm, and the common anisotropic NdFeB powder is ground to an average particle size of about 130˜170 μm before mixing thereof.

11. The method for producing magnetic powder according to claim 9, wherein the isotropic magnetic powder produced in the first step is ground to an average particle size of about 100˜225 μm, the common anisotropic SmFeN powder is ground to an average particle size of about 3˜5 μm, and the common anisotropic NdFeB powder is ground to an average particle size of about 130˜170 μm before mixing thereof.

12. A method for producing a magnet comprising:
a first step of producing a R—Fe—B-based rare earth isotropic magnetic powder using a scrap rare earth magnet through a hydrogenation, disproportionation, hydrogen desorption, recombination (HDDR) process;
a second step of mixing the R—Fe—B-based rare earth isotropic magnetic powder with an anisotropic magnetic powder;
a third step of kneading a thermosetting or thermoplastic synthetic resin in with the mixture from the second step; and
a fourth step of forming a magnetic field using a magnetic field forming machine.

13. The method for producing magnet according to claim 12, wherein the third step comprises kneading the synthetic resin at a ratio of about 1˜10 wt % synthetic resin based on the total weight of the synthetic resin plus the mixture from the second step.

14. The method for producing magnet according to claim 12, wherein the third step comprises kneading the synthetic resin followed by drying at about 60° C. or less under a vacuum condition for about 30 min˜2 hours.

15. The method for producing magnet according to claim 12, wherein the fourth step comprises molding a magnetic field compression-molded body having a density of about 5.5 g/cc or more at a pressure of about 6˜14 ton/cm² or less.

16. The method for producing magnet according to claim 15, wherein the fourth step comprises heat-treating at about 130˜170° C. for about 30 min˜2 hours after molding the magnetic field compression-molded body.

17. The method for producing magnet according to claim 12, which further comprises a fifth step of heating at about 80˜120° C. for about 20˜40 min.
